(19) United States
(12) Patent Application Publication
(10) Pub. No.: US 2023/0064474 A1
(43) Pub. Date: Mar. 2, 2023

(54) A Cartridge for a Vapour Generating Device

(71) Applicant: JT International SA, Geneva (CH)

(72) Inventors: Takeshi Akiyama, Tokyo (JP); Peter Loveday, Epsom Surrey (GB)

(73) Assignee: JT International SA, Geneva (CH)

(21) Appl. No.: 17/797,247

(22) PCT Filed: Feb. 2, 2021
(86) PCT No.: PCT/EP2021/052406

§ 371 Date: Aug. 3, 2022

(30) Foreign Application Priority Data
Feb. 5, 2020 (EP) 20155707.1

(51) Int. Cl. A24F 40/42; A24F 40/46; A24F 40/10

(52) U.S. Cl. CPC A24F 40/42; A24F 40/46; A24F 40/10

(57) ABSTRACT

A cartridge for a vapour generating device includes a fluid permeable heater and a porous liquid transfer element. The porous liquid transfer element is configured to convey vapour generating liquid to the fluid permeable heater and has one or more recesses accommodating at least part of the fluid permeable heater.

### TECHNICAL FIELD

The present disclosure relates generally to a cartridge for a vapour generating device configured to heat a vapour generating liquid to generate a vapour which cools and condenses to form an aerosol for inhalation by a user of the device. Embodiments of the present disclosure also relate to a vapour generating system comprising a vapour generating device and a cartridge configured to be used with the vapour generating device.

### TECHNICAL BACKGROUND

The term vapour generating device (or more commonly electronic cigarette or e-cigarette) refers to a handheld electronic device that is intended to simulate the feeling or experience of smoking tobacco in a traditional cigarette. Electronic cigarettes work by heating a vapour generating liquid to generate a vapour that cools and condenses to form an aerosol which is then inhaled by the user. Accordingly, using e-cigarettes is also sometimes referred to as “vaping”. The vapour generating liquid usually comprises nicotine, propylene glycol, glycerine and flavourings.

Typical e-cigarette vaporizing units, i.e. systems or sub-systems for vaporizing the vapour generating liquid, utilize a cotton wick and heating element to produce vapour from liquid stored in a capsule or tank. When a user operates the e-cigarette, liquid that has soaked into the wick is heated by the heating element, producing a vapour which cools and condenses to form an aerosol which may then be inhaled. To facilitate the ease of use of e-cigarettes, cartridges are often used. These cartridges are often configured as “cartomizers”, which means an integrated component formed from a liquid store, a liquid transfer element (e.g. a wick) and a heater. Electrical connectors may also be provided to establish an electrical connection between the heating element and a power source. However, the complexity and numerous components of such cartridges are associated with drawbacks, such as a complex and costly manufacturing process.

In view of the above, it would be desirable to provide a cartridge with improved manufacturability and which efficiently heats the vapour generating liquid.

### SUMMARY OF THE DISCLOSURE

According to a first aspect of the present disclosure, there is provided a cartridge for a vapour generating device, the cartridge comprising:
a fluid permeable heater;
a porous liquid transfer element configured to convey vapour generating liquid to the fluid permeable heater, the porous liquid transfer element having one or more recesses accommodating at least part of the fluid permeable heater.

The cartridge is intended for use with a vapour generating device configured to heat the vapour generating liquid to volatise at least one component of the vapour generating liquid and thereby generate a vapour which cools and condenses to form an aerosol for inhalation by a user of the vapour generating device.

According to a second aspect of the present disclosure, there is provided a vapour generating system comprising a vapour generating device and a cartridge configured to be used with the vapour generating device, wherein:
the cartridge comprises:
   a fluid permeable heater comprising an inductively heatable susceptor;
   a porous liquid transfer element configured to convey vapour generating liquid to the inductively heatable susceptor, the porous liquid transfer element having one or more recesses accommodating at least part of the inductively heatable susceptor;
the vapour generating device comprises an electromagnetic field generator positioned adjacent to the inductively heatable susceptor for inductively heating the inductively heatable susceptor.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The porous liquid transfer element provides a reliable and efficient transfer of vapour generating liquid to the fluid permeable heater, thereby ensuring that the vapour generating liquid is efficiently heated by the fluid permeable heater. The cartridge also has improved manufacturability because at least part of the fluid permeable heater is accommodated in one or more recesses in the porous liquid transfer element.

As used herein, the term “fluid permeable” heater means a heater that allows a liquid or gas to permeate through it. For example, the fluid permeable heater may include a plurality of openings or perforations or may have an open-porous structure which allows fluid to permeate through it. In particular, the fluid permeable heater allows the vapour generating liquid or the resulting vapour generated by heating the vapour generating liquid to permeate through it.

The vapour generating liquid may comprise polyhydric alcohols and mixtures thereof such as glycerine or propylene glycol. The vapour generating liquid may contain nicotine.

The fluid permeable heater may comprise a resistive heater. The resistive heater may comprise a resistive heating element. The vapour generating device may include a power source, e.g. a battery, which may be connectable to the resistive heater. In operation, upon activating the vapour generating device, the power source electrically heats the resistive heater, which then heats the vapour generating liquid, resulting in vaporization of the vapour generating liquid.

The fluid permeable heater may comprise an inductively heatable susceptor. The vapour generating device may comprise an electromagnetic field generator, e.g. an induction coil, arranged to generate an alternating electromagnetic field for inductively heating the inductively heatable susceptor. This arrangement provides a particularly convenient way to heat and vaporize the vapour generating liquid using induction heating.

The induction coil may comprise a Litz wire or a Litz cable. It will, however, be understood that other materials could be used.

The inductively heatable susceptor may comprise one or more, but not limited, of aluminium, iron, nickel, stainless steel, copper, and alloys thereof, e.g. Nickel Chromium or Nickel Copper. With the application of an electromagnetic field in its vicinity, for example generated by the electromagnetic field generator, the susceptor may generate heat due to eddy currents and magnetic hysteresis losses resulting in a conversion of energy from electromagnetic to heat.

The electromagnetic field generator may be arranged to operate in use with a fluctuating electromagnetic field having a magnetic flux density of between approximately 20 mT and approximately 2.0 T at the point of highest concentration.

The vapour generating device may include circuitry. The power source and circuitry may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The porous liquid transfer element may comprise a capillary material. The capillary material may comprise a porous ceramic material. The porous liquid transfer element contacts the vapour generating liquid to enable absorption of the vapour generating liquid by the capillary material, for example due to capillary action or wicking.

The fluid permeable heater may be arranged in coaxial alignment with the porous liquid transfer element. A simplified cartridge structure may thereby be achieved, contributing to the improved manufacturability of the cartridge.

The fluid permeable heater and the porous liquid transfer element may form a vapour generating unit. The vapour generating unit can be manufactured as a subassembly, thereby contributing to the improved manufacturability of the cartridge.

The cartridge may comprise a liquid store configured to store vapour generating liquid and may comprise a closure for sealing the liquid store. The closure may comprise a recess which may support the vapour generating unit. The vapour generating unit is thereby reliably supported in a desired position.

The porous liquid transfer element may include an outer surface which may be exposed to an inner space of the liquid store. Such an arrangement allows the vapour generating liquid to be readily absorbed by the outer surface of the liquid transfer element and to be conveyed to the fluid permeable heater by the liquid transfer element.

The outer surface may extend around an entire periphery of the porous liquid transfer element. Such an arrangement helps to ensure that a sufficient amount of vapour generating liquid is constantly conveyed by the liquid transfer element to the fluid permeable heater at all positions around the periphery of the liquid transfer element during use of the cartridge with a vapour generating device.

The closure may include at least one air inlet for conveying air to the vapour generating unit. A reliable airflow to the vapour generating unit is thereby assured, in turn ensuring that vapour is efficiently generated.

The cartridge may comprise a vapour outlet channel. The closure, the vapour generating unit and the vapour outlet channel may be arranged in abutting coaxial alignment. Assembly of the closure, the vapour generating unit and the vapour outlet channel may thus be facilitated, thereby contributing to the improved manufacturability of the cartridge.

The porous liquid transfer element may define a substantially cylindrical vaporization chamber. The substantially cylindrical vaporization chamber may be fluidly connected to the vapour outlet channel. Efficient vapour generation is thereby assured. In particular, a continuous process is achieved in which vapour generating liquid, e.g. from the liquid store, is continuously absorbed by the porous liquid transfer element and conveyed to the fluid permeable heater where it is heated to generate a vapour in the vaporization chamber. Vapour generated during this process is transferred from the vaporization chamber via the vapour outlet channel in the cartridge so that it can be inhaled by a user of the vapour generating device/system.

The fluid permeable heater may comprise a heater ring, e.g. susceptor ring, which may be positioned at an axial end of the vaporization chamber, e.g. adjacent to the closure. The fluid permeable heater may comprise pair of heater rings, e.g. susceptor rings, which may be spaced from each other in an axial direction of the cylindrical vaporization chamber. The heater rings can be easily accommodated in corresponding recesses in the porous liquid transfer element, thereby improving the manufacturability of the cartridge whilst at the same time ensuring efficient vapour generation.

The fluid permeable heater may comprise a substantially tubular heater which may be positioned inside the substantially cylindrical vaporization chamber and which may extend axially along an inner surface of the substantially cylindrical vaporization chamber. The substantially tubular heater can be easily accommodated in an axially extending recess within the porous liquid transfer element, thereby improving the manufacturability of the cartridge whilst at the same time ensuring efficient vapour generation within the vaporization chamber.

The substantially tubular heater may include a plurality of perforations. The perforations allow vapour generating liquid and/or vapour (generated by heating the vapour generating liquid) to easily pass through the substantially tubular heater into the vaporization chamber, thus ensuring that vapour is generated efficiently and can be transferred to the vapour outlet channel.

The perforations in the substantially tubular heater may be arranged in circumferentially adjacent rows and the perforations in each row may be axially offset from the perforations in circumferentially adjacent rows. The perforations in the substantially tubular heater are, thus, staggered, which may provide an improved transfer of vapour generating liquid and/or vapour (generated by heating the vapour generating liquid) to the vaporization chamber and, thus, efficient vapour generation.

### BRIEF DESCRIPTION OF THE DRAWINGS

FIG. 1 is a diagrammatic cutaway perspective view of a first example of a cartridge for a vapour generating device;

FIG. 2 is a diagrammatic cutaway side view of the cartridge of FIG. 1;

FIG. 3 is an exploded perspective view of the cartridge of FIGS. 1 and 2;

FIG. 4 is a diagrammatic cutaway perspective view of a vapour generating unit of the cartridge illustrated FIGS. 1 to 3;

FIG. 5 is a diagrammatic perspective view of a sub-assembly comprising the vapour generating unit illustrated in FIG. 4 and sealing members;

FIGS. 6 and 7 are diagrammatic perspective top and bottom views respectively of a closure of the cartridge illustrated FIGS. 1 to 3;

FIG. 8 is a diagrammatic cutaway perspective view of a second example of a cartridge for a vapour generating device;

FIG. 9 is a diagrammatic cutaway side view of the cartridge of FIG. 8;

FIG. 10 is a diagrammatic cutaway perspective view of a vapour generating unit of the cartridge illustrated FIGS. 8 and 9;

FIG. 11 is a diagrammatic perspective view of a sub-assembly comprising the vapour generating unit illustrated in FIG. 10 and sealing members; and

FIG. 12 is a diagrammatic view of a vapour generating system comprising a vapour generating device and a cartridge.

### DETAILED DESCRIPTION OF EMBODIMENTS

Embodiments of the present disclosure will now be described by way of example only and with reference to the accompanying drawings.

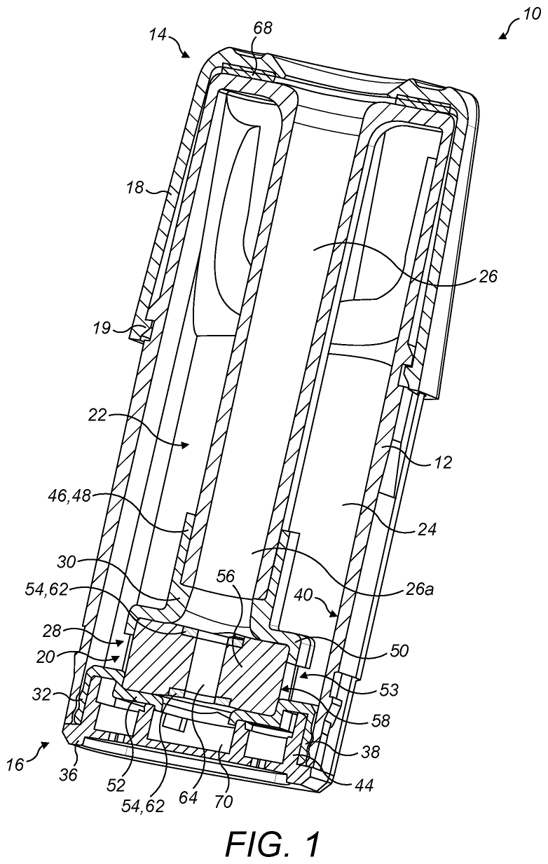

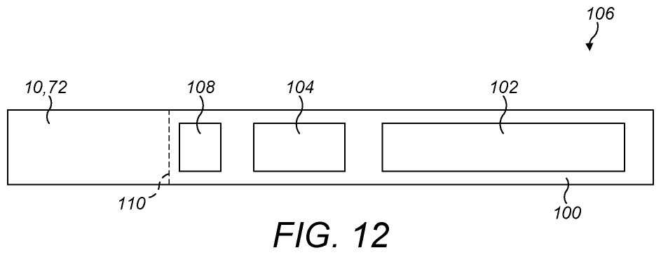

Referring initially to FIGS. 1 to 7, there is shown a first example of a cartridge 10 according to the present disclosure. The cartridge 10 is configured to be used with a vapour generating device 100 as shown diagrammatically in FIG. 12. The vapour generating device 100 comprises a power source (e.g. a battery) 102 and circuitry 104, such that the cartridge 10 and the vapour generating device 100 together form a vapour generating system 106. In an embodiment, the cartridge 10 is releasably connectable to the vapour generating device 100 by a releasable connection 110. The releasable connection 110 can, for example, be a snap-fit connection or alternatively a threaded connection or a bayonet connection.

The cartridge 10 comprises a cartridge housing 12 having a proximal end 14 and a distal end 16. The proximal end 14 may constitute a mouthpiece end configured for being introduced directly into a user's mouth and may, therefore, also be designated as the mouth end 14. In the illustrated example, a mouthpiece 18 is fitted to the proximal (mouth) end 14 and is secured in position on the cartridge housing 12 by a snap-fit connection 19. The cartridge 10 comprises a base portion 20 and a liquid storage portion 22, and the liquid storage portion 22 comprises a liquid store 24, configured for containing therein a vapour generating liquid, and a vapour outlet channel 26. The vapour generating liquid may comprise an aerosol-forming substance such as propylene glycol and/or glycerol and may contain other substances such as nicotine and acids. The vapour generating liquid may also comprise flavourings such as e.g. tobacco, menthol or fruit flavour. The liquid store 24 may extend generally between the proximal (mouth) end 14 and the distal end 16. The liquid store 24 may surround, and coextend with, the vapour outlet channel 26.

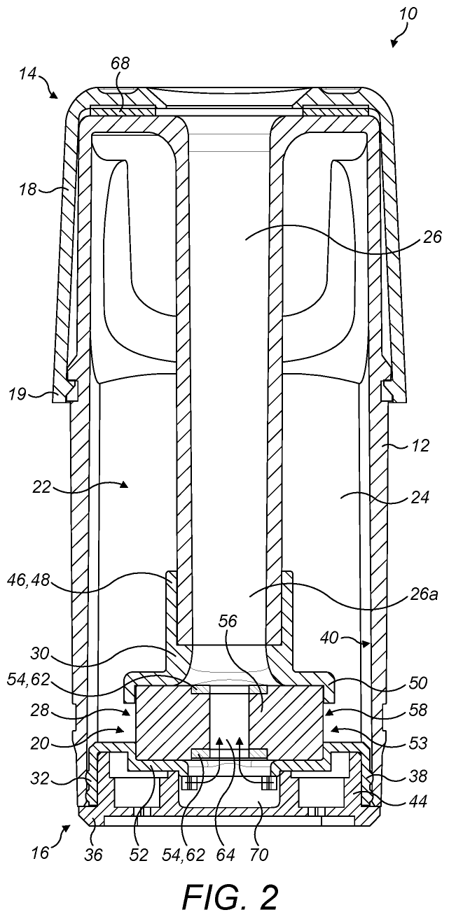

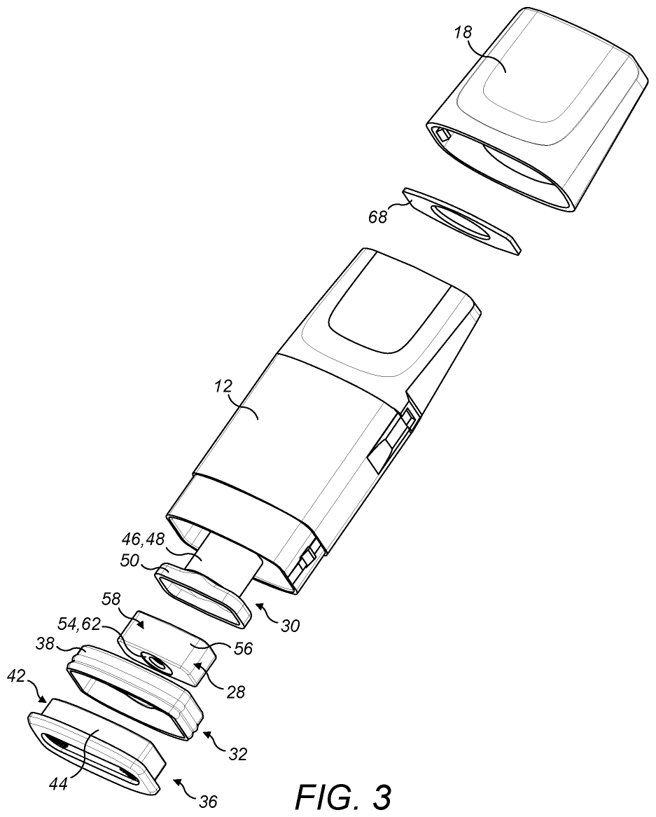

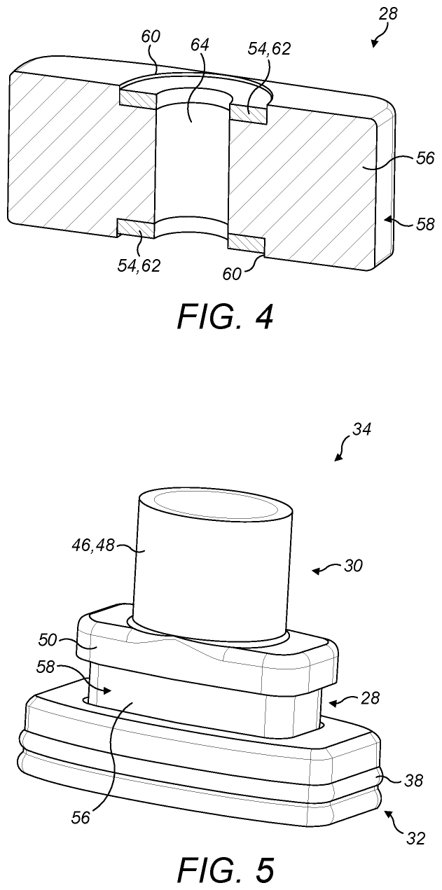

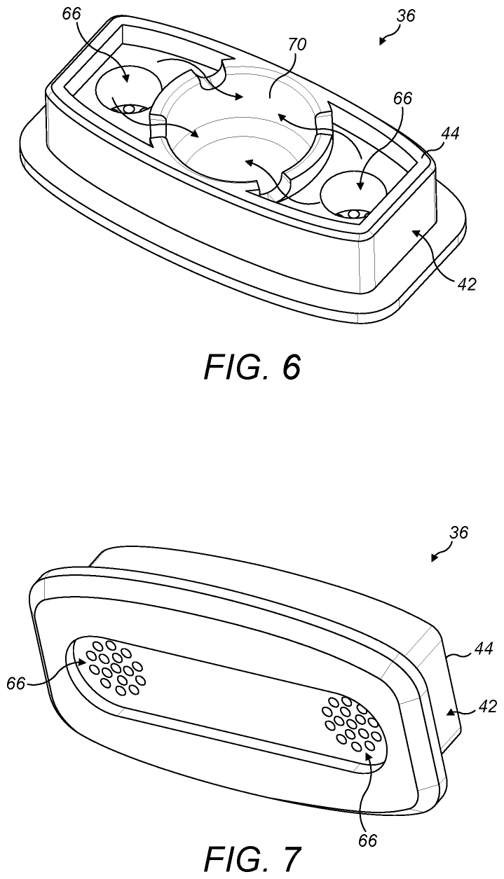

As best seen in FIGS. 1 and 2, the base portion 20 of the cartridge 10 may be configured to sealingly close off the distal end 16 of the cartridge 10. The base portion 20 comprises a vapour generating unit 28 best seen in FIGS. 3 and 4, upper and lower sealing members 30, 32 which, together with the vapour generating unit 28, form a subassembly 34 as shown in FIG. 5, and a closure 36 shown separately in FIGS. 6 and 7. The subassembly 34 and closure 36 are positioned at the distal end 16 of the cartridge housing 12, and more particularly in the space formed between the liquid store 24 and the distal end 16. The subassembly 34 and closure 36 cooperate to close the distal end 16 of the cartridge housing 12 and thereby retain the vapour generating liquid in the liquid store 24.

The lower sealing member 32 is provided with an outer sealing portion 38 that is in contact on one side with an inner surface 40 of the liquid store 24 at the distal end 16 of the cartridge housing 12 and on an opposite side with an outwardly facing surface 42 of a peripheral skirt 44 of the closure 36. The lower sealing member 32 may be formed of a material with an elasticity that provides a sealing effect when the outer sealing portion 38 contacts the inner surface 40 of the liquid store 24 and the outwardly facing surface 42 of the peripheral skirt 44. For example, the lower sealing member 32 may comprise rubber or silicone.

The upper sealing member 30 comprises a connecting portion 46 which is configured to sealingly connect to a distal end 26a of the vapour outlet channel 26. The connecting portion 46 includes an annular flange 48 configured to seal against the outer circumferential surface of the vapour outlet channel 26 at the distal end 26a. The upper sealing member 30 may be formed of the same material as the lower sealing member 32.

The upper and lower sealing members 30, 32 include respectively upper and lower sealing portions 50, 52 which define therebetween a cavity 53 in which the vapour generating unit 28 is accommodated. The upper and lower sealing portions 50, 52 are configured to sealingly engage the vapour generating unit 28 as can be seen clearly in FIGS. 1, 2 and 5.

The vapour generating unit 28 comprises a fluid permeable heater 54 and a porous liquid transfer element 56 configured to convey vapour generating liquid from the liquid store 24 to the fluid permeable heater 54 so that the vapour generating liquid can be heated and vaporized.

The porous liquid transfer element 56 comprises a capillary material, such as a porous ceramic material, and includes an outer surface 58 which extends around the entire periphery of the liquid transfer element 56 and which is exposed to an inner space of the liquid store 24 in the region formed between the upper and lower sealing portions 50, 52. Vapour generating liquid is thereby absorbed into the porous liquid transfer element 56 via the outer surface 58 and is conveyed, for example by a wicking action, to the fluid permeable heater 54 so that it can be heated and vaporized. The porous liquid transfer element 56 includes at least one recess 60, and in the illustrated first example two axially spaced recesses 60 formed in upper and lower surfaces, which accommodate the fluid permeable heater 54.

As best seen in FIGS. 1, 2 and 4, the fluid permeable heater 54 comprises a pair of axially spaced heater rings 62 which are arranged in coaxial alignment with the porous liquid transfer element 56. The heater rings 62 may comprise an inductively heatable susceptor material and, thus, may constitute susceptor rings 62. As will be understood by one of ordinary skill in the art, when the susceptor rings 62 are exposed to an alternating and time-varying electromagnetic field generated by an electromagnetic field generator 108 of a vapour generating device 100 (see FIG. 12), eddy currents and/or magnetic hysteresis losses are generated in the susceptor rings 62 causing them to heat up. The heat is transferred from the susceptor rings 62 to the vapour generating liquid absorbed by the porous liquid transfer element 56, for example by conduction, radiation and convection, thereby heating and vaporizing the vapour generating liquid.

The porous liquid transfer element 56 defines a substantially cylindrical vaporization chamber 64 which is aligned with, and fluidly connected to, the vapour outlet channel 26 and in particular to the distal end 26a. The vaporization chamber 64 thus provides a route which allows vapour generated by heating the vapour generating liquid absorbed by the porous liquid transfer element 56 to be transferred into the vapour outlet channel 26 where it cools and condenses to form an aerosol that can be inhaled by a user via the mouthpiece 18 at the proximal (mouth) end 14. In the illustrated first example, and as discussed earlier in this specification, the fluid permeable heater 54 (i.e. the susceptor rings 62) has an open-porous structure which allows the vapour generating liquid from the liquid store 24 and/or the generated vapour to permeate through it, into the vaporization chamber 64. As an alternative to an open-porous structure, the fluid permeable heater 54 (i.e. the susceptor rings 62) could include a plurality of openings or perforations.

In operation, vapour generating liquid is absorbed by the porous liquid transfer element 56 via the outer surface 58 and conveyed to the fluid permeable heater 54. As noted above, when the cartridge 10 is used with a vapour generating device 100 including an electromagnetic field generator 108, the susceptor rings 62 are inductively heated by the electromagnetic field generator 108. The heat from the susceptor rings 62 is transferred to vapour generating liquid absorbed by the porous liquid transfer element 56, resulting in the generation of a vapour. The vapour escapes from the porous liquid transfer element 56 into the vaporization chamber 64, and then flows from the vaporization chamber 64 along the vapour outlet channel 26 where it cools and condenses to form an aerosol that is inhaled by a user through the mouthpiece 18. The vaporization of the vapour generating liquid is facilitated by the addition of air from the surrounding environment through air inlets 66 formed in the closure 36 (best seen in FIGS. 6 and 7). The flow of air and/or vapour through the cartridge 10, i.e. from the air inlets 66, through the vaporization chamber 64, along the vapour outlet channel 26, and out of the mouthpiece 18, is aided by negative pressure created by a user drawing air from the proximal (mouth) end 14 using the mouthpiece 18. As best seen in FIGS. 1 and 2, a mouthpiece seal 68 is located between the mouthpiece 18 and the cartridge housing 12 to provide a seal between these two components.

An advantage of the cartridge 10 according to the present disclosure is that it can be assembled with relative ease due to its simplified structure, and it may be possible to automate some or all of the assembly process. Individual parts that can be assembled together to form the subassembly 34 illustrated in FIG. 5 include the vapour generating unit 28 and the upper and lower sealing members 30, 32. The subassembly 34 can be conveniently accommodated in, and supported by, a centrally positioned recess 70 in the closure 36 (see FIG. 6) which may further facilitate the assembly of the cartridge 10 and ensure the correct positioning of the vapour generating unit 28 at the distal end 16 of the cartridge housing 12.

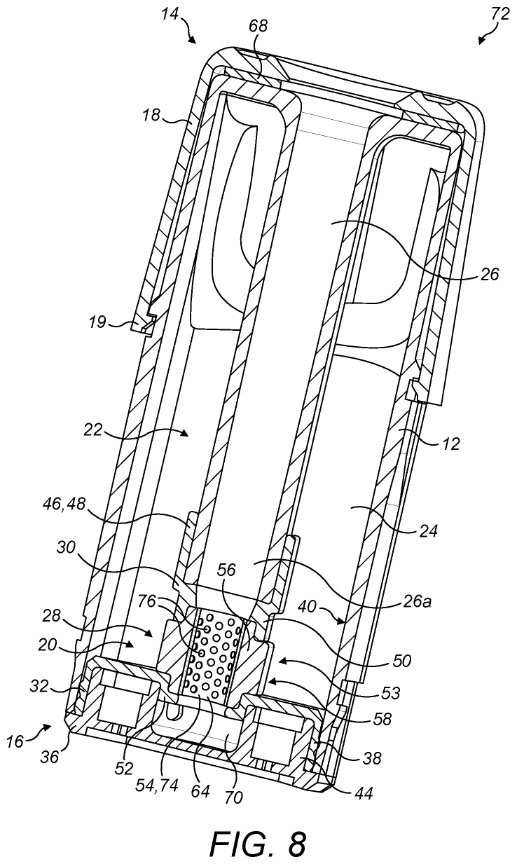

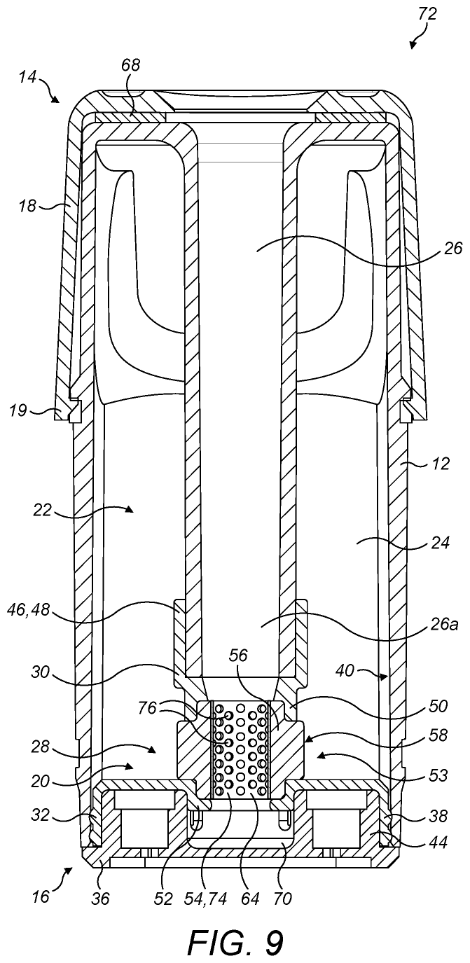

Referring now to FIGS. 8 to 11, there is shown a second example of a cartridge 72 according to the present disclosure. The cartridge 72 is similar to the cartridge 10 described above with reference to FIGS. 1 to 7 and corresponding elements are designated using the same reference numerals. The cartridge 72 is also configured for use with a vapour generating device 100 as described above with reference to FIG. 12 such that the cartridge 72 and vapour generating device 100 together form a vapour generating system 106.

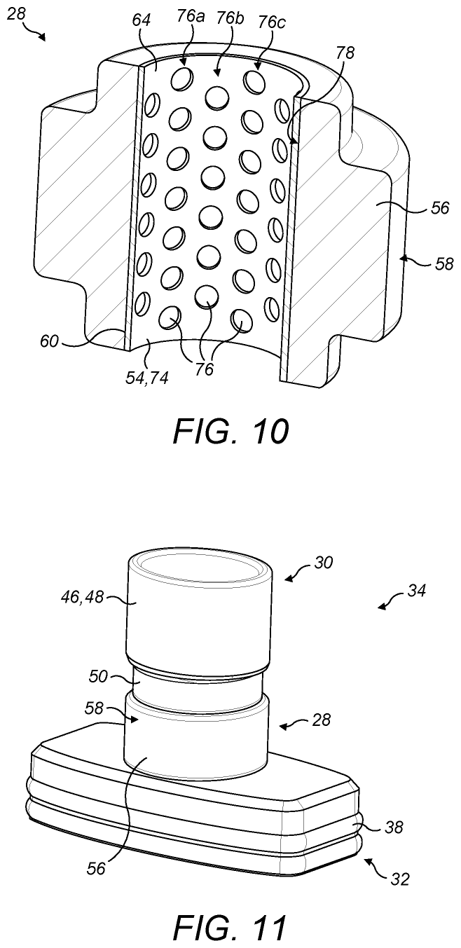

In the second example, and as best seen in FIGS. 8 to 10, the fluid permeable heater 54 comprises a substantially tubular heater 74 which is positioned inside the substantially cylindrical vaporization chamber 64 and which extends axially along an inner surface 78 of the porous liquid transfer element 56. In this second example, the inner surface 78 constitutes a recess 60 in which the tubular heater 74 is accommodated and also constitutes an inner surface of the vaporization chamber 64. In order to allow the flow of vapour generating liquid and/or vapour from the porous liquid transfer element 56 into the vaporization chamber 64, the tubular heater 74 includes a plurality of perforations 76. In the illustrated example, the perforations are arranged in circumferentially adjacent rows 76a, 76b, 76c (see FIG. 10), with the perforations 76 in each row (e.g. row 76b) being axially offset from the perforations 76 in circumferentially adjacent rows (e.g. 76a, 76c) to provide a staggered arrangement of the perforations 76.

The tubular heater 74 may comprise an inductively heatable susceptor material and, thus, may constitute a tubular susceptor 74. As will be understood by one of ordinary skill in the art, when the tubular susceptor 74 is exposed to an alternating and time-varying electromagnetic field generated by an electromagnetic field generator 108 of a vapour generating device 100, eddy currents and/or magnetic hysteresis losses are generated in the tubular susceptor 74 causing it to heat up. The heat is transferred from the tubular susceptor 74 to the vapour generating liquid absorbed by the porous liquid transfer element 56, for example by conduction, radiation and convection, thereby heating and vaporizing the vapour generating liquid to generate a vapour. The vapour passes through the perforations 76 in the tubular susceptor 74 and into the vaporization chamber 64, before the vapour is transferred into the vapour outlet channel 26 where it cools and condenses to form an aerosol that can be inhaled by a user via the mouthpiece 18 at the proximal (mouth) end 14.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

For example, the heater rings 62 and/or the tubular heater 74 could comprise a resistively heatable material which is configured to be resistively heated (rather than inductively heated) when the cartridge 10, 72 is used with the vapour generating device 100. In this case, it will be understood that the vapour generating device 100 will not include an electromagnetic field generator 108, but instead appropriate electrical connections for connecting the power source 102 to the heater rings 62 or the tubular heater 74.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A cartridge for a vapour generating device, the cartridge comprising:
a fluid permeable heater;
a porous liquid transfer element configured to convey vapour generating liquid to the fluid permeable heater, the porous liquid transfer element having one or more recesses accommodating at least part of the fluid permeable heater.

2. The cartridge according to claim 1, wherein the fluid permeable heater comprises a resistive heater.

3. The cartridge according to claim 1, wherein the fluid permeable heater comprises an inductively heatable susceptor.

4. The cartridge according to claim 1, wherein the porous liquid transfer element comprises a capillary material.

5. The cartridge according to claim 1, wherein the fluid permeable heater is arranged in coaxial alignment with the porous liquid transfer element.

6. The cartridge according to claim 1, further comprising a liquid store configured to store vapour generating liquid and a closure for sealing the liquid store wherein the closure comprises a recess supporting a vapour generating unit formed by the fluid permeable heater and the porous liquid transfer element.

7. The cartridge according to claim 6, wherein the porous liquid transfer element includes an outer surface exposed to an inner space of the liquid store.

8. The cartridge according to claim 7, wherein the outer surface extends around an entire periphery of the porous liquid transfer element.

9. The cartridge according to claim 6, wherein the closure includes at least one air inlet for conveying air to the vapour generating unit.

10. The cartridge according to claim 6, further comprising a vapour outlet channel, wherein the closure, the vapour generating unit and the vapour outlet channel are arranged in abutting coaxial alignment.

11. The cartridge according to claim 1, wherein the porous liquid transfer element defines a substantially cylindrical vaporization chamber.

12. The cartridge according to claim 10, wherein the porous liquid transfer element defines a substantially cylindrical vaporization chamber fluidly connected to the vapour outlet channel.

13. The cartridge according to claim 11, wherein the fluid permeable heater comprises a pair of heater rings which are spaced from each other in an axial direction of the substantially cylindrical vaporization chamber.

14. The cartridge according to claim 11, wherein the fluid permeable heater comprises a substantially tubular heater which is positioned inside the substantially cylindrical vaporization chamber and which extends axially along an inner surface of the substantially cylindrical vaporization chamber.

15. The cartridge according to claim 14, wherein the substantially tubular heater includes a plurality of perforations.

16. The cartridge according to claim 4, wherein the capillary material comprises a porous ceramic material.
